(19) United States
(12) Patent Application Publication
(10) Pub. No.: US 2019/0023591 A1
(43) Pub. Date: Jan. 24, 2019

(54) Collection of Metal Ions from Water Mixtures Using Nanotechnology

(71) Applicant: University of South Carolina, Columbia, SC (US)

(72) Inventor: Jamie Lead, Chapin, SC (US)

(21) Appl. No.: 15/804,371

(22) Filed: Nov. 6, 2017

Related U.S. Application Data
(60) Provisional application No. 62/534,889, filed on Jul. 20, 2017.

(51) Int. Cl. C02F 1/48

(52) U.S. Cl. CPC C02F 1/48; C02F 2101/20

(57) ABSTRACT

A method for the removal of metals (Cd, Cr, Ni, Zn, and Pb) from a body of water is provided. In summary, polyvinylpyrrolidone coated magnetic nanoparticles (PVP-Fe₃O₄ NPs) can remove metals (Cd, Cr, Ni, Zn, and Pb) from synthetic soft water and sea water in acidic or non-acidic conditions. The PVP-Fe₃O₄NPs can remove up to about 100% of Cd, Cr, Ni, Zn, and Pb metal ions at a concentration of 0.1 mg/L and more than 80% of the metal ions at a concentration of 1 mg/L. Further, the majority of metal sorption by the nanoparticles can occurred within the first 3 hours of treatment.

### RELATED APPLICATIONS

The present application claims priority to U.S. Provisional Application Ser. No. 62/534,889, filed on Jul. 20, 2017, which is incorporated herein in its entirety by reference thereto.

### BACKGROUND

Water pollution is a major global challenge given the increasing growth in industry and the expanding human population. Certain metals can be highly toxic and contribute significantly to water pollution. Metals, such as cadmium (Cd), chromium (Cr), nickel (Ni) and lead (Pb) are highly toxic. These metals have a number of human and environmental health adverse outcomes including kidney failure, softening of bones, prostate cancer and damage to the liver, to children's central nervous system and to the reproductive system. These metals are a potential risk, given these hazards and their wide exposure in the environment, including bioaccumulation and bio-magnification.

The United States Environmental Protection Agency (USEPA) has set the maximum contaminant levels (MCL), which is the highest level of a contaminant that is allowed in drinking water, at 0.005 milligrams per liter for Cd, 0.1 milligrams per liter for Cr, 0.1 milligrams per liter for Ni, and 0.015 milligrams per liter for Pb, due to this hazard. Higher levels of soil exposure to the contaminants are permitted. To date, many technologies have been used for in-situ and ex-situ remediation, such as stabilization, solidification, soil flushing, chemical reduction/oxidation, electro kinetics, low temperature thermal desorption, incineration, excavation/retrieval, disposal phytoremediation and landfill. However, these technologies are often expensive, inefficient, time-consuming and destructive.

Recently, nanotechnology has been shown to provide a potentially cheaper and more effective solution for environmental clean-up in pollution prevention, detection, monitoring and remediation. Reactive nanomaterials such as nanoscale zeolites, metal oxides, carbon nanotubes and fibers, bimetallic nanoparticles have been used for water remediation. For instance, iron oxide nanoparticles can be used due to their large specific surface area and ease of separation from water media; where the nanoparticle (NP) is magnetite, a facile magnetic separation of NPs, along with associated contaminants, can be effected. For instance, Fe₃O₄ and SiO₂ magnetic nanoparticles coated with poly(1-vinylimidazole) oligomer have been used to remove Hg(II) from water, carbon-encapsulated nanomagnets have been used to extract metals in acidic solutions, and ferromagnetic carbon-coated Fe nanoparticles have been use to remove nearly 95% Cr (VI) from aqueous solution. However, bare magnetite nanoparticles easily aggregate in aqueous systems and are highly susceptible to transformations in acidic and oxic environmental conditions, necessitating the use of appropriate capping agents. On the other hand, protected nanoparticles, such as magnetite with a porous carbon shell, can remove metals in acidic suspensions, with high efficiency through electrostatic attraction and sorption. Nevertheless, a need still exists for a nanoparticle system that can efficiently remove metals under a wide variety of conditions based on the water type (acidic, sea water, soft water, etc.), without transforming.

As such, an efficient, cost-effective, non-destructive nanoparticle system and method for the collection and/or removal of metals from a body of water would be beneficial and has been developed.

### SUMMARY OF THE INVENTION

The present invention is directed to a method of extracting metal ions from a polluted liquid. The method includes introducing the polluted liquid to a plurality of nanoparticles, wherein the nanoparticles each comprise a core and an organic shell; and allowing metal ions in the polluted liquid to be adsorbed by the plurality of nanoparticles.

In one particular embodiment, the method can further include removing the nanoparticles from the polluted liquid. Further, the core can be magnetic, wherein removing the nanoparticles from the multiphasic liquid can be achieved utilizing a magnetic force. In addition, the method can further include recovering the metal ions adsorbed by the plurality of nanoparticles.

In another embodiment, the method of introducing the polluted liquid to a plurality of nanoparticles can include flowing the polluted liquid through a cartridge, wherein the cartridge comprises the plurality of nanoparticles.

In another embodiment, the core can include a metal oxide. In addition, the metal oxide can be iron oxide (Fe₃O₄), silica, alumina, indium tin oxide, titania, or a combination thereof. For instance, the core can be Fe₃O₄.

In still another embodiment, the organic shell can include a polymer such as a polyvinylpyrrolidone-based polymer. Further, the polyvinylpyrrolidone-based polymer can have a molecular mass of about 10 kDa to about 360 kDa. For example, the polymeric shell can be polyvinylpyrrolidone.

In one specific embodiment, the core can include Fe₃O₄ and the organic shell can include polyvinylpyrrolidone.

In an additional embodiment, the core can have an average size that is about 100 nanometers (nm) or less.

In one more embodiment, the metal ions can be present in the polluted liquid at a concentration ranging from about 0.001 milligrams per liter of polluted liquid to about 150 milligrams per liter of polluted liquid.

In still another embodiment, up to about 100% (e.g., from about 40% to about 100%, dependent on pH and ionic strength) of the metal ions can be adsorbed by the plurality of nanoparticles within about 24 hours, wherein the metal ions are present at an initial concentration of up to about 1 milligram per liter of polluted liquid.

In yet another embodiment, about 80% to about 100% of the metal ions can be adsorbed by the plurality of nanoparticles within about 24 hours (e.g., such as within about 3 hours), wherein the metal ions are present at an initial concentration of up to about 1 milligram per liter of polluted liquid.

In an additional embodiment, the plurality of nanoparticles can have an adsorption capacity ranging from about 10 milligrams of metal ions per gram of nanoparticles to about 70 milligrams of metal ions per gram of nanoparticles.

In one more embodiment, the polluted liquid can include metal ions of cadmium, chromium, nickel, lead, zinc, or a combination thereof.

In one particular embodiment, the polluted liquid can include lead. Further, about 90% to about 100% of the lead can be adsorbed by the plurality of nanoparticles within a time period of up to about 3 hours, wherein the lead is present at an initial concentration of up to about 1 milligram per liter of polluted liquid. In general, these removal percentages are for solution and treatment conditions which are environmentally realistic.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows an exemplary nanoparticle having a core surrounded by a polymeric shell;

FIG. 2 shows a magnet removing nanoparticles from a multiphasic liquid;

FIG. 3 shows a multiphasic liquid flowing through a cartridge containing nanoparticles;

FIG. 4 is a graph showing the effects of metal speciation (Cd, Cr, Ni, and Pb) on PVP-Fe₃O₄ nanoparticle removal efficiency in EPA soft water;

FIG. 5 is a graph showing the effects of metal speciation (Cd, Cr, Ni, and Pb) on PVP-Fe₃O₄ nanoparticle removal efficiency in EPA sea water;

FIG. 6 is a bar graph showing the effect of initial metal concentration (mg/L) in EPA soft water on metal removal rate;

FIG. 7 is a bar graph showing the effect of initial metal concentration (mg/L) in EPA sea water on metal removal rate;

FIG. 8 is a graph showing the influence of contact time on the adsorption of various metals (Cd, Cr, Ni, and Pb; 1 milligram/liter) in EPA soft water;

FIG. 9 is a graph showing the influence of contact time on the adsorption of various metals (Cd, Cr, Ni, and Pb; 1 milligram/liter) in EPA sea water;

FIG. 10 is a graph showing the effect of contact time on pseudo-second-order kinetics of the adsorption of four metals (Cd, Cr, Ni, and Pb) in soft water;

FIG. 11 is a graph showing the effect of contact time on pseudo-second-order kinetics of the adsorption of four metals (Cd, Cr, Ni, and Pb) in sea water;

FIG. 12 is a graph comparing the efficiency of freshly synthesized nanoparticles and 3-week old nanoparticles in removing Cd (1 milligram/liter) from soft water;

FIG. 13 is a graph comparing the efficiency of freshly synthesized nanoparticles and 3-week old nanoparticles in removing Cr (1 milligram/liter) from soft water;

FIG. 14 is a graph comparing the efficiency of freshly synthesized nanoparticles and 3-week old nanoparticles in removing Ni (1 milligram/liter) from soft water;

FIG. 15 is a graph showing the effects of adding fulvic acid (FA) on Cd removal efficiency in soft water;

FIG. 16 is a graph showing the effects of adding fulvic acid (FA) on Cr removal efficiency in soft water;

FIG. 17 is a graph showing the effects of adding fulvic acid (FA) on Ni removal efficiency in soft water;

FIG. 18 is a graph showing the effects of adding fulvic acid (FA) on Pb removal efficiency in soft water;

FIG. 19 is a graph showing the effects of adding fulvic acid (FA) on Cd removal efficiency in sea water;

FIG. 20 is a graph showing the effects of adding fulvic acid (FA) on Cr removal efficiency in sea water;

FIG. 21 is a graph showing the effects of adding fulvic acid (FA) on Ni removal efficiency in sea water; and

FIG. 22 is a graph showing the effects of adding fulvic acid (FA) on Pb removal efficiency in sea water.

Repeat use of reference characters in the present specification and drawings is intended to represent the same or analogous features or elements of the present invention.

### Definitions

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the prefix “nano” refers a scale of about 1 nm to about 100 nm. For example, particles having an average diameter on the nanometer scale (e.g., from about 1 nm to about 100 nm) are referred to as “nanoparticles.” Particles having an average diameter of greater than 1,000 nm (i.e., 1 μm) are generally referred to as “microparticles,” since the micrometer scale generally involves those materials having an average size of greater than 1 μm.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Methods are generally provided for using nanoparticles to quantitatively remove metals and metal species (e.g., metal ions and metal complexes) from a polluted liquid (e.g., sea water). The application is potentially suitable for metal recovery after spills and discharges. Subsequent recovery of the metals is feasible. In one particular embodiment, polyvinylpyrrolidone coated magnetic nanoparticles (PVP-Fe₃O₄ NPs) were used to remove heavy metals (Cd, Cr, Ni, Zn, and Pb) from soft water and sea water in the presence and absence of fulvic acid. PVP-Fe₃O₄ NPs is an environmental friendly material a low cost, low toxicity method of synthesis has been developed. PVP has been shown to prevent nanoparticle transformations in the environment and thus allows removal over longer periods of time.

For instance, when the metal ions are present at a concentration ranging from about 0.001 milligrams per liter of polluted liquid to about 150 milligrams per liter of polluted liquid, from about 40% to about 100% of the metal ions can be adsorbed by the plurality of nanoparticles within a time period of less than about 24 hours, regardless of whether the polluted liquid is soft water or sea water. Specifically, when the metal ions are present at an initial concentration of up to about 1 milligram per liter of polluted liquid, typical of highly contaminated waters, from about 80% to about 100% of the metal ions can be adsorbed by the plurality of nanoparticles within a time period of less than about 24 hours. In the case of lead (Pb) specifically, where the lead is present at an initial concentration of up to about 1 milligram per liter of polluted liquid, from about 90% to about 100% of the metal ions can be adsorbed by the plurality of nanoparticles within a time period of less than about 3 hours, regardless of whether the polluted liquid is soft water or sea water.

Additionally, the plurality of nanoparticles have an adsorption capacity ranging from about 10 milligrams of metal ions per gram of nanoparticles to about 70 milligrams of metal ions per gram of nanoparticles. For instance, the plurality of nanoparticles have an adsorption capacity for lead ranging from about 20 milligrams of metal ions per gram of nanoparticles to about 70 milligrams of metal ions per gram of nanoparticles, regardless of whether the polluted liquid was soft water or sea water and whether or not fulvic acid is present. Further, when the metal ions are present in soft water or sea water without the presence of fulvic acid, the plurality of nanoparticles have an adsorption capacity for lead ranging from about 55 milligrams of metal ions per gram of nanoparticles to about 70 milligrams of metal ions per gram of nanoparticles.

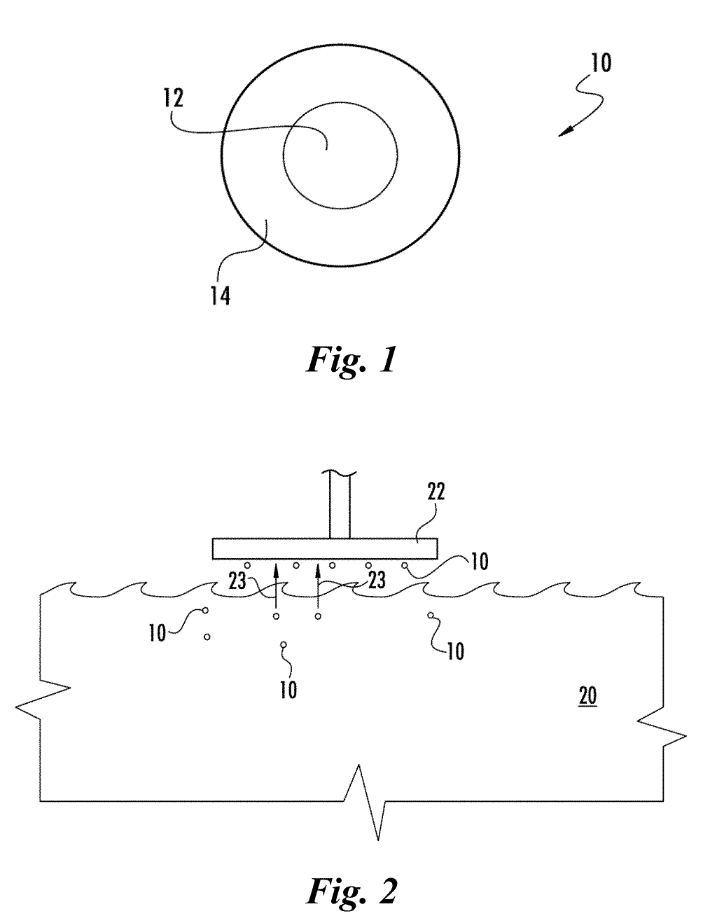

The nanoparticles are generally formed from a core and polymeric shell, which are each discussed in greater detail below. Referring to FIG. 1, an exemplary nanoparticle 10 is shown having a core 12 surrounded by a polymeric shell 14. Although shown as a spherical nanoparticle 10, it is to be understood that the nanoparticle 10 can take on any suitable shape (e.g., nanoflake, nanorod, etc.). Particles described in U.S. Patent Publication No. 2015/0309043, which is incorporated by reference herein, are particularly suitable.

I. Nanoparticle Core

The presently disclosed methods can be utilized on a variety of different types of nanoparticle cores. The nanoparticle may comprise, for example, natural or synthetic nanoclays (including those made from amorphous or structured clays), inorganic metal oxides, nanolatexes, organic nanoparticles, etc. Particularly suitable nanoparticle cores include inorganic nanoparticles, such as iron oxide (e.g., magnetite (Fe₃O₄) or goethite FeO(OH)), silica, alumina, a titanium oxide, indium tin oxide (ITO), CdSe, or a mixture thereof. Other suitable nanoparticles include carbon-based nanoparticles such as graphene, fullerenes, carbon nanotubes, or a mixture thereof.

The nanoparticle core can, in one embodiment, be a core-shell nanoparticle itself. For example, the nanoparticle core can include a core of a first material (e.g., a magnetite core) with a shell of a second material (e.g., a goethite shell).

In one embodiment, the nanoparticle core can be a metal oxide nanoparticle core, such as an iron oxide (e.g., magnetite (Fe₃O₄) or goethite FeO(OH)), silica, an aluminum oxide (e.g., alumina), a copper oxide, a zinc oxide, indium tin oxide, a titanium oxide, nickel oxides, cobalt oxides, or mixtures thereof. Such metal oxides can be in any form of the combination of the metal, oxygen, and optionally another element (e.g., another metal). For example, suitable iron oxides can include iron(II) oxide (FeO), iron(II,III) oxide (Fe₃O₄), iron(III) oxide (Fe₂O₃), FeO(OH), etc. Similarly, suitable titanium oxides can include titanium dioxide (TiO₂), titanium(II) oxide (TiO), titanium(III) oxide (Ti₂O₃), etc. Likewise, suitable copper oxides can include cuprous oxide (Cu₂O), cupric oxide (CuO), etc. In another embodiment, the core can be magnetite core with a ferrihydrite shell, noting that this shell is separate and distinct from the polymeric shell discussed in more detail below.

Particularly suitable are iron oxide nanoparticles, for use as the core in the resulting coated nanoparticle, can have a diameter between about 1 nm and about 100 nm, where at least one part (either core or shell) can be formed primarily of magnetite (Fe₃O₄) with minor amounts of its oxidized form maghemite (γ-Fe₂O₃). Such iron oxide cores have superparamagnetic properties (a.k.a., SPIONs) that can be particularly suitable for certain embodiments.

In one particular embodiment, the core can be magnetic (e.g., a magnetite iron oxide core) to allow for separation/removal/extraction of the nanoparticle from the multiphasic liquid utilizing a magnetic force. Of course, other suitable magnetic materials can be utilized, such as nickel oxides, cobalt oxides, etc.

The core can, in certain embodiments, have an average diameter that about 100 nm or less, such as from about 1 nm to about 100 nm, such as about 15 nm to about 50 nm, such as from about 15 nm to about 25 nm. Such a relatively small size can ensure a high surface area for the polymer shell to create sufficient metal adsorption capabilities.

The core can be made up of a single nanoparticle or an agglomeration/aggregation of nanoparticles, where such an agglomeration/aggregation facilitates separation by magnets. As such, the core may have a size of about 15 nm to about 50 nm when relatively few nanoparticles form the core (e.g., 1 to about 10 nanoparticles), or can be larger when the core is formed from a larger agglomeration of nanoparticles (e.g., having a core size of about 50 nm to about 500 nm formed from a plurality of nanoparticles). Agglomeration is increased somewhat in the presence of metal ions and in high ionic strength solutions. The core and shell can be made of a single crystal (i.e., regular 3D arrangements of atoms), particles (single crystal or multiple crystals), or particles formed from agglomerates or aggregates (weakly and strongly bound).

II. Nanoparticle Shell

An organic nanoparticle shell is generally positioned around the nanoparticle core, which can optionally be contained within an inorganic shell so as to form a two or three layer core-shell nanoparticle (e.g., inorganic core-organic shell; inorganic core-inorganic shell-organic shell, etc.). The outermost nanoparticle shell can be polymeric or can contain macromolecules, macroions, or small organic ions, which may or may not be polymeric. The nanoparticle shell can be formed around a core formed from a single nanoparticle or an agglomeration of nanoparticles. In one particular embodiment, the shell can be in the form of a polymeric sheath having a thickness of about 1 nm to about 50 nm on the core. The polymeric sheath may be chemically bonded to the core, and/or may be mechanically bonded around the core depending on the interaction between the particular polymeric material utilized and the particular core present.

The organic nanoparticle shell can be formed from a polymeric material that comprises at least one polymer. In one embodiment, the polymeric nanoparticle shell can include a polyvinylpyrrolidone-based polymer (e.g., a PVP-based polymer), either alone or in a polymeric matrix with another polymer, in order to protect the core from transformations in the environment. For example, a PVP-based polymer can be at least 50% by weight of the polymeric material of the polymeric shell, such as about 75% to 100% by weight. In one embodiment, the PVP-based polymer can be at least 90% by weight of the polymeric material of the polymeric shell, such as about 95% to 100% by weight. The PVP-based polymer can be polyvinylpyrrolidone (PVP) or a polyvinylpyrrolidone derivative having the core backbone based on the PVP polymeric structure.

The PVP-based polymers can have, in particular embodiments, a molecular mass of about 10 kDa to about 360 kDa, with the lower end of the range showing most effective for metal adsorption (e.g., about 10 kDa to about 200 kDa).

The PVP-based polymer can be utilized alone (i.e., without another polymeric material) to form the sheath, or can be utilized in a mixture with another polymeric material. For example, any polymer having aliphatic and aromatic structures similar to hydrocarbons can be mixed with the PVP-based polymer to for the sheath.

In one embodiment, the PVP coating can be formed through a reaction process utilizing an aqueous solvent and at reaction temperatures of less than about 100° C. (e.g., about 60° C. to about 95° C.). The advantages of using the (1) aqueous solvent and (2) the lower reaction temps allows for the reaction to be more environmentally friendly in that no organic solvents are utilized (which also reduces cost).

III. Separation of Metals from a Polluted Liquid

A plurality of the nanoparticles, such as those described above, are generally introduced to the polluted liquid such that the metal particles/ions in the polluted liquid are allowed to be adsorbed by the polymeric shell of the nanoparticles.

In one embodiment, the nanoparticles can be added into (e.g., floated on, submerged within, dispersed and/or suspended therein, etc.) the polluted liquid. Such an introduction of the nanoparticles to the polluted liquid can be particularly useful in large, natural bodies of water (e.g., an ocean, gulf, lake, river, groundwater, etc.). For example, a large plurality of nanoparticles can be introduced to an area of a polluted spill in a natural body of water. Then, after a sufficient contact time to allow the polluted liquid to be adsorbed by the core, the nanoparticles can be removed from the polluted liquid. For example, easy magnetic separation or a size-based separation such as ultra(filtration) can be used. With magnetic separation, a magnet can be placed near or in the polluted liquid with the nanoparticles such that the nanoparticles are magnetically attracted to the magnet and removed from the polluted liquid. The metal can also be physically or chemically bound to the nanoparticle (e.g., the metal can be bound to the nanoparticle surface), such that removal of the nanoparticles will remove the associated metals.

Referring to FIG. 2, an exemplary magnet 22 is shown in close proximity to the polluted liquid 22 to remove nanoparticles 10 therefrom, utilizing a magnetic force (shown as arrows 23). Of course, the magnet 22 can be placed into the polluted liquid 20 (e.g., on the surface of, submerged under, etc.) to collect the nanoparticles 10 from the polluted liquid 22. When utilized in a large body of water (e.g., the ocean, gulf, lake, river, groundwater, etc.), the magnet 22 can be suspended from a boat, buoy etc. in order to collect the nanoparticles 10 from the polluted liquid 22. Alternatively, the nanoparticles 10 can be added to the polluted liquid 22 and remain in the polluted liquid 22, where the nanoparticles uptake the metal, where the metal remains in the body of water but in a form that is no longer toxic.

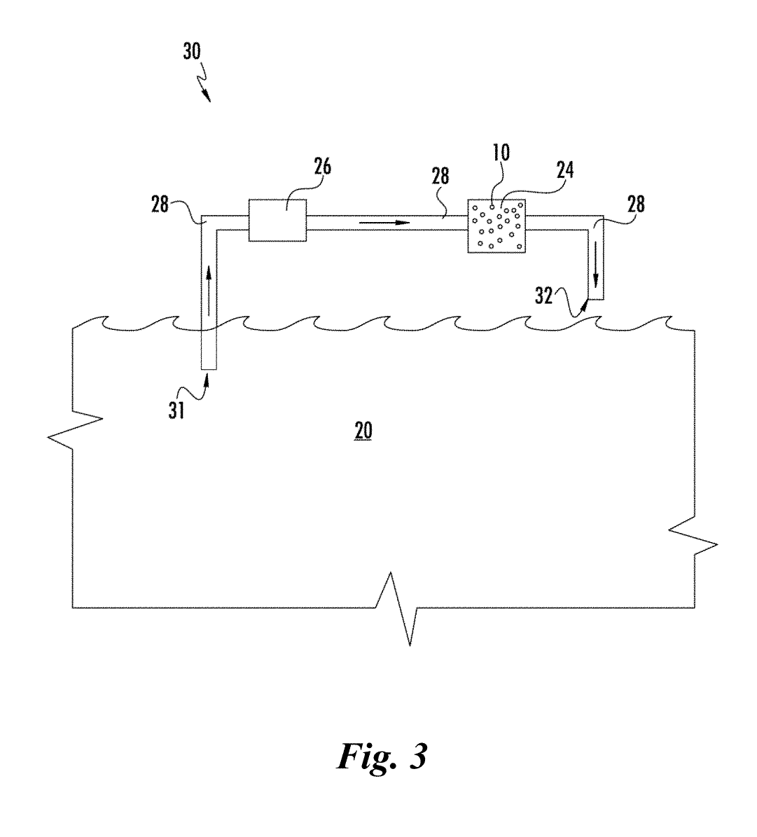

In an alternative removal method, the polluted liquid can be passed through a cartridge containing a plurality of the nanoparticles. Referring to FIG. 3, an exemplary system 30 is shown, where the polluted liquid 20 flows through a cartridge 24 containing the nanoparticles 10. In the exemplary system 30 shown, the polluted liquid 20 is generally pumped into an inlet 31 through the piping 28 (utilizing a pump 26) through the cartridge 24 and returned to the polluted liquid 20 via outlet 32.

In any event, these methods are directed to metal aggregation and/or recovery, while utilizing low toxicity nanomaterials that can be formed through a facile, cheap synthesis process using low energy and material inputs. The presently disclosed methods work effectively under environmental conditions including seawater salinity and the presence of natural organic macromolecules such as humic substances, fulvic acid, etc. Through the presently disclosed methods, up to about 100% of metal (e.g., Cd, Cr, Ni, Zn, and Pb) present at a concentration of 0.1 milligrams per liter in a body of water can be achieved within three hours of contact with the nanoparticles of the present invention, in particular embodiments. Further, up to about 80% of metal (e.g., Cd, Cr, Ni, Zn and Pb) present at a concentration of about 1.0 milligrams per liter in a body of water can be achieved within 24 hours (e.g., within 3 hours to within 24 hours) of contact with the nanoparticles of the present invention, in particular embodiments. Further, essentially 100% of Pb can be removed under all concentrations and conditions described herein. Finally, the methods are generally resistant to dynamic changes in the environment due to oxidation, sulfidation, aggregation and eco-corona formation.

The present invention may be better understood with reference to the following example.

### Example

### Methodology

### Chemicals/Materials

PVP (MW 10 kDa), cadmium nitrate (Cd(NO₃)₂.4H₂O, 99%), lead nitrate Pb(NO₃)₂, 99%), nickel nitrate (Ni(NO₃)₂.6H₂O, 99%), potassium dichromate (K₂CrO7, 99%) were purchased from Sigma-Aldrich. FeCl₃.6H₂O (>98%) and ammonium hydroxide (NH₄OH, 25-30%) were obtained from BDH and FeCl₂.4H2O (98%) was obtained from Alfa Aesar. All chemicals were used as received without further purification.

Preparation and Characterization of PVP-Fe₃O₄

28.8 mM of PVP was added to 6.25 mL ultrapure water (UHP, maximum resistivity 18.2 MΩ cm) while the solution was stirred at 80±5° C. After this, 160 mM FeCl₂.4H₂O and 640 mM FeCl₃.6H₂O were added to the solution while the solution was stirred and the temperature was kept constant. Next 19.2 mM PVP was dissolved in the solution. Finally, 6.25 mL ammonium hydroxide was added into the solution dropwise with vigorous stirring and the solution was mixed for 25 minutes at 90±5° C. and then taken off the heat. After the precipitates reached room temperature, they were washed once with ultrapure water and separated using a 1.5 inch cubic neodymium magnet (Grade N 52, K&J Magnetics Inc.) and redispersed in ultrapure water by sonication.

The median particle size and hydrodynamic size of the PVP-Fe₃O₄ were 11.2 nanometers (nm) (interquartile range: 6.3-18.3 nm) and 127.4±4.2 nm, respectively, as measured by atomic force microscopy (AFM) and dynamic light scattering (DLS), respectively. The Fourier transform infrared spectrometer (FTIR) result suggests that NPs are coated by PVP and likely through the PVP carbonyl group as reported elsewhere. Also, the thermogravimetric analysis (TGA) shows that 8.5% of mass of NPs belong to the PVP coating and 91.5% to the iron oxide cores. Based on X-ray diffraction (XRD), magnetite (Fe₃O₄) is the dominant phase of NPs.

### Metals Adsorption Analysis

1 milliliter (mL) PVP-Fe₃O₄ suspension (1000 mg l⁻¹) was added into 5 mL metal solution, which equals 1 milligram nanomaterials added into 6 mL solution. This value is similar to or smaller than many other studies in the literature such as 2.5 mg/5 mL, 1 gram/liter, and 20 mg/10 mL. The suspensions were sonicated for 30 minutes and shaken (200 rpm) at 25° C. for 30 minutes to 24 hours. PVP-Fe₃O₄ NPs were then separated by cubic magnet (Grade N 52, K&J magnetic Inc.) until the nanoparticles were completely separated. The supernatant was then collected for metal element analysis by inductively coupled plasma optical emission spectrometry (ICP-OES).

Effects of metal species and initial concentration, water media, and contact time were evaluated at concentrations of 0.1 mg/L, 1 mg/L, 10 mg/L, and 100 mg/L of Cd (II), Cr (VI), Pb (II), Ni (II) ions in aqueous solutions, where the solutions were prepared separately by dissolving their respective nitrate or potassium salt. These concentrations were selected based on a concentration range frequently observed in contaminated waters. To evaluate the removal efficiency under more realistic environmental conditions, two aqueous test media (EPA soft water and marine water) were used, either with or without 0.5 mg/L of Suwannee River fulvic acid (SRFA). The different contact time periods were 1.5 hours, 3 hours, 6 hours, 12 hours, and 24 hours. In addition, the effect of PVP-Fe₃O₄ NPs aggregation was also evaluated. Further, fresh synthesized and three weeks old PVP-Fe₃O₄ NPs were used to remove metals present in soft water at a concentration of 1 mg/L, where the three weeks old NPs were sonicated for 30 minutes before addition into the metal solutions.

Metal adsorption per unit of adsorbent at time t was calculated by equation (1):

$${q}_{t} = \frac{( {C}_{0} - {C}_{t} ) V}{M} \qquad ( 1 )$$

where C₀ (mg/L) is the initial metal ion concentration, Cₜ (mg/L) is the concentration after adsorption at time t, V (L) is the solution volume and M (g) is the mass of adsorbent.

The removal rate was calculated by equation (2):

$$\% Removal = \frac{( {C}_{0} - {C}_{e} )}{{C}_{0}} \times 100 \qquad ( 2 )$$

where C₀ and Cₑ are the initial and final concentrations of metal ion in the solution. All adsorption experiments were conducted in triplicate and the mean of three values was expressed as the result.

### Kinetics Modeling Study

In order to investigate the mechanism and rate of the metal adsorption process, kinetics models were used in this study. A pseudo-second-order kinetic model which is given in the following equation:

t/qₜ=1/k₂qₑ²+t/qₑ(k₀=k₂qₑ²) (4)

where k₂ (g mg⁻¹ h⁻¹) is the rate constant of the pseudo-second-order model of adsorption. The straight line plots of t/qₜ versus t are used to obtain the constants for pseudo-second-order reaction. K₀ is the initial sorption rate.

### Results and Discussion

### Metal Removal Test

### Different Metal Species and Concentrations

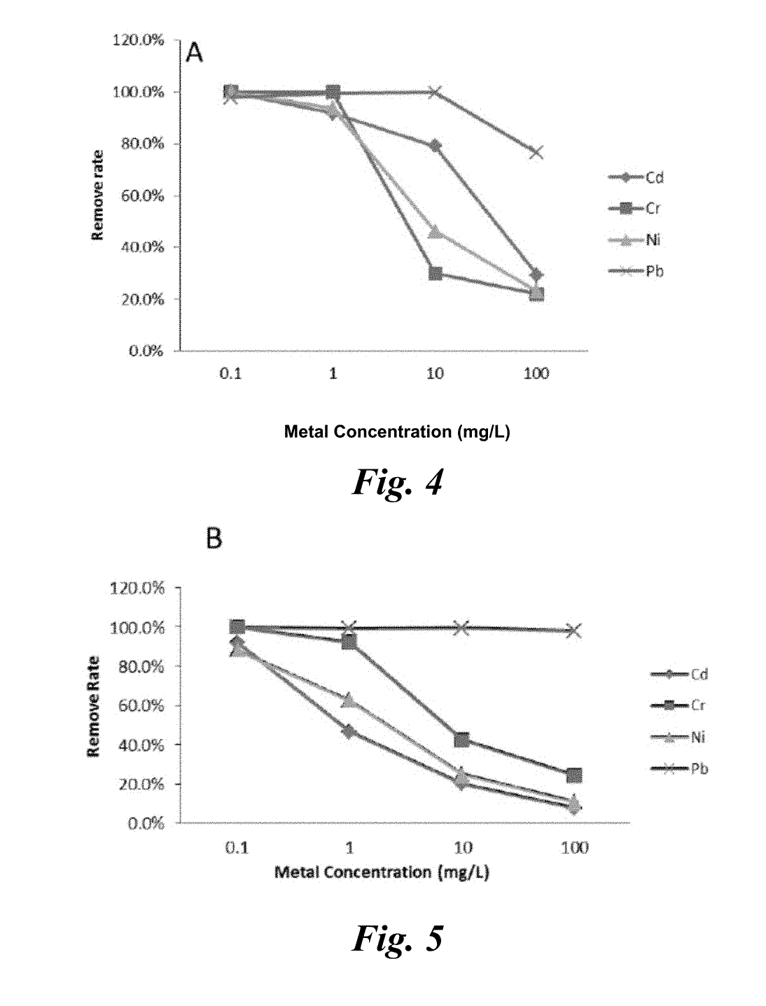

The metal removal efficiency using PVP-Fe₃O₄NPs in inorganic water media is shown in FIG. 4 for soft water and FIG. 5 for EPA sea water. It is clear that at the lowest metal concentration (0.1 mg/L), the removal percentages are nearly 100% for all four metals in both soft water and sea water conditions. At 1 mg/L (NPs: metal w/w is 150:1), Pb, Ni, and Cd had more than 90% removal rate in softer water, while Pb and Cr had more than 90% removal rate in sea water media. At higher concentrations (10 mg/L and 100 mg/L), only Pb achieved high (above 80%) removal percentage. Apparently, lead ions have higher adsorption affinity to the PVP-Fe₃O₄ NPs than other three ions, although all ions had high adsorption affinity at 0.1 mg/L concentrations.

In the aqueous solution, metal ions can present as stable ions or can hydrolyze and complex to form a complex, such as:

Mⁿ⁺+nH₂O↔M(OH)ₙ^{(m-n)-}nH⁺

where M stands for metal. Under the environmental conditions studied, iron oxide nanoparticles acquires a negative charge by deprotonation in the aqueous leading to increased attraction by electrostatic attraction.

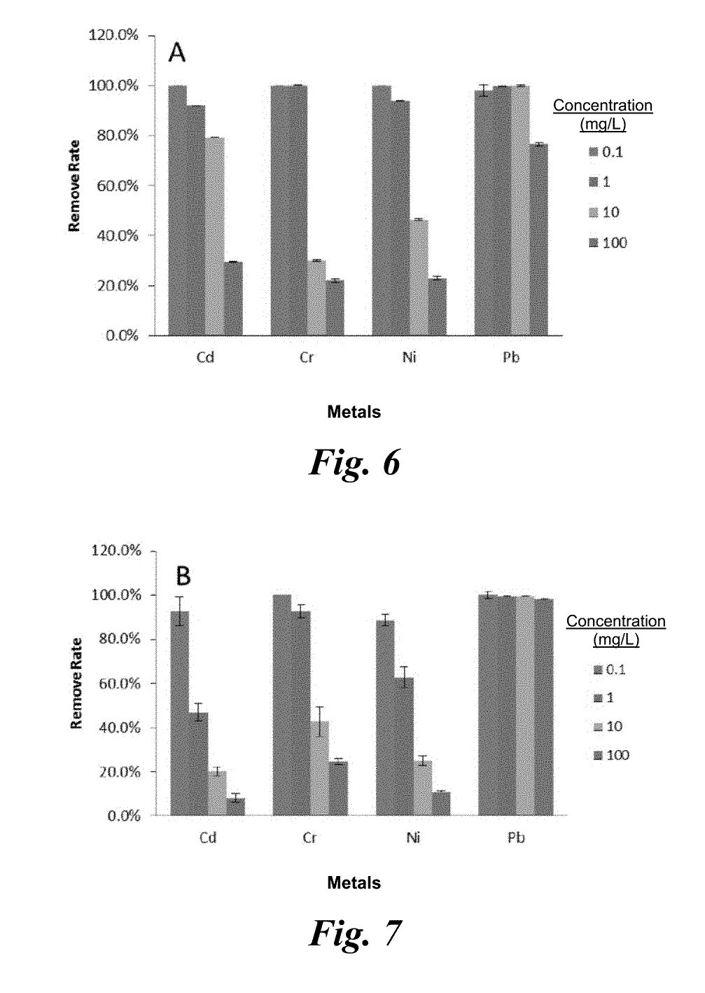

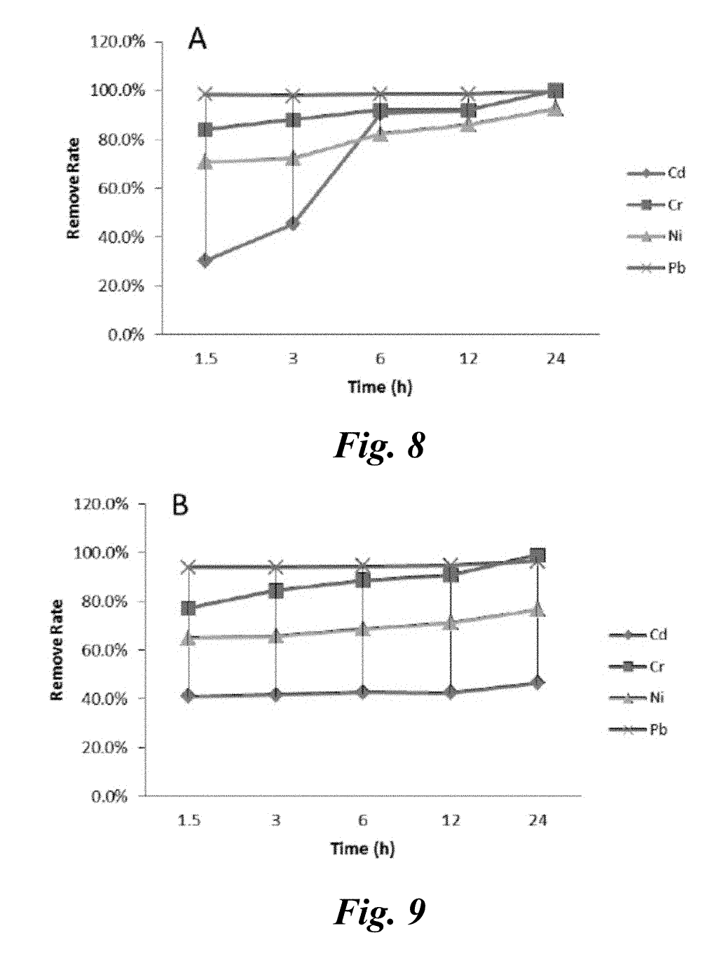

Further, the effects of different initial metal concentrations in milligrams per liter on removal rate are shown in FIGS. 6-7, where it was determined that when the initial metal concentration was increased, the removal efficiency of metal decreased when metal was present in soft water (FIG. 6) or sea water (FIG. 7). This phenomenon could be explained by the adsorption capacity and the complexing power of the ligand. The nanoparticles could only adsorb certain amount of metal ions in the aqueous solution and the process will be stopped when the adsorption reached saturation. This is also shown in FIGS. 8-9, which indicate that the absorbance changes along with contact time for EPA soft water (FIG. 8) and EPA sea water (FIG. 9) and plateaus after a certain amount of contact time, which are discussed in more detail below.

### Effect of Contact Time

The contact time is an important parameter for water treatment application. Effect of contact time on metal adsorption was investigated at 1.5, 3, 6, 12 and 24 hours with an initial metal concentration of 1 mg/L. It can be seen from FIGS. 8-9 that the adsorption of all the metals increased with contact time. In soft water (FIG. 8), Cd, Cr and Ni removal increased from 30.3% to 93.5%, 84.0% to 100%, and 70.8% to 92.6%, respectively, as the contact time was increased from 1.5 h to 24 h. In sea water (FIG. 9), metal removal generally slightly decreased because of decreased electrostatic attraction caused by charge shielding at the higher ionic strength. This time is short compared to other adsorbents, such as activated carbon, where several hours are required for maximum for activated carbon and clay minerals, where 4 hours are required for maximum adsorption. This fast ion removal is related to the highly dispersed nature of the nano-adsorbents and the high specific surface area. The nanoparticles presented here are non-porous; with porous adsorbents, ion diffusion into pore spaces retards completion of the adsorption process.

### Kinetic Studies

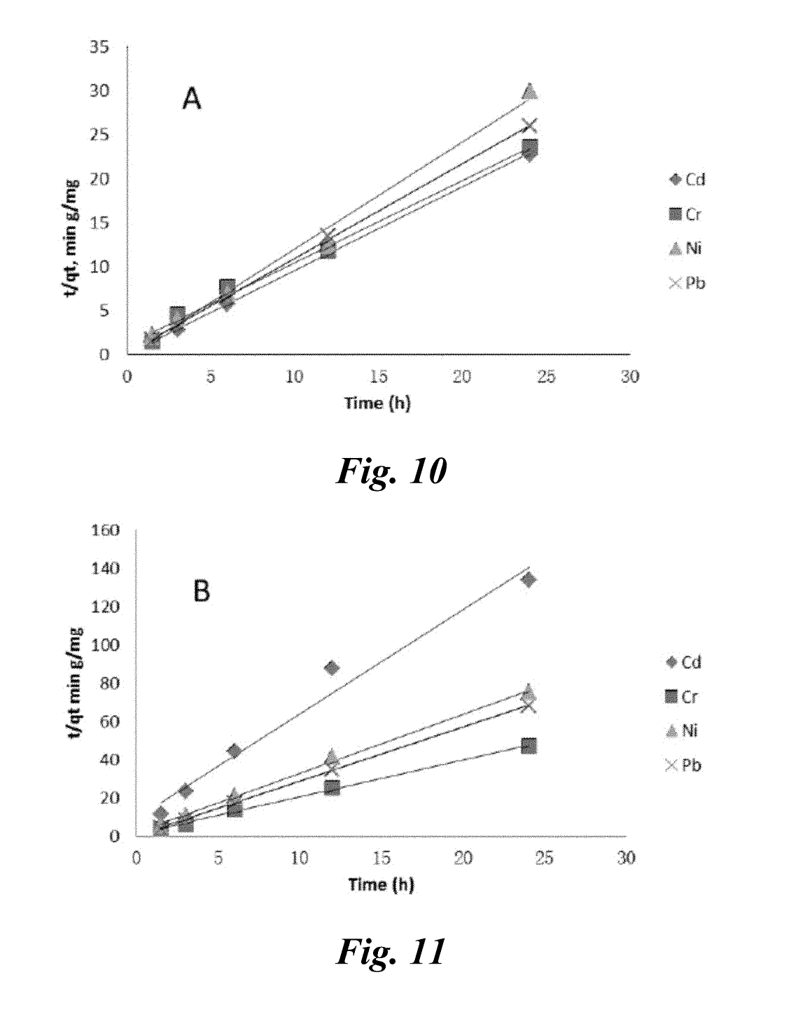

Adsorption kinetic models not only allow for estimation of adsorption rate but also provide insights into rate expression characteristic of possible reaction mechanisms. FIGS. 10-11 show the pseudo-second-order sorption kinetics of adsorption of four metals in soft water (FIG. 10) and sea water (FIG. 11). The order of adsorption in soft water was Ni²⁺>Pb²⁺>Cr⁶⁺>Cd²⁺ and the order of adsorption in sea water was Cd²⁺>Ni²⁺>Pb²⁺>Cr⁶⁺. The values of correlation factor R², obtained from the plots of pseudo-second-order kinetics shown in Table 1 below are greater (R²>0.99) showing good agreement between model and data.

TABLE 1
Correlation (R²) obtained from pseudo-second-order
equation of metal removal using PVP-Fe₃O₄ NPs

| | Cd | Cr | Ni | Pb |
|---|---|---|---|---|
| soft water | 0.9994 | 0.9908 | 0.9896 | 0.9996 |
| sea water | 0.9753 | 0.9979 | 0.9974 | 0.9999 |

This agreements suggests that adsorption of Cd, Cr, Ni and Pb onto PVP-Fe₃O₄ NPs follows the pseudo-second-order model well. The pseudo-second-order adsorption model is based on the assumption that the rate-controlling step of chemisorption involves valence forces through sharing or exchange of electrons between adsorbent and adsorbate. The pseudo-second-order adsorption model has also been reported for some heavy metals on many adsorbents such as functionalized magnetic mesoporous silica, polyethylenimine grafted magnetic porous adsorbent, monodispersed magnetite nanoparticles, and magnetic magnetite nanoparticles.

### Different Storage Period of Nanoparticles

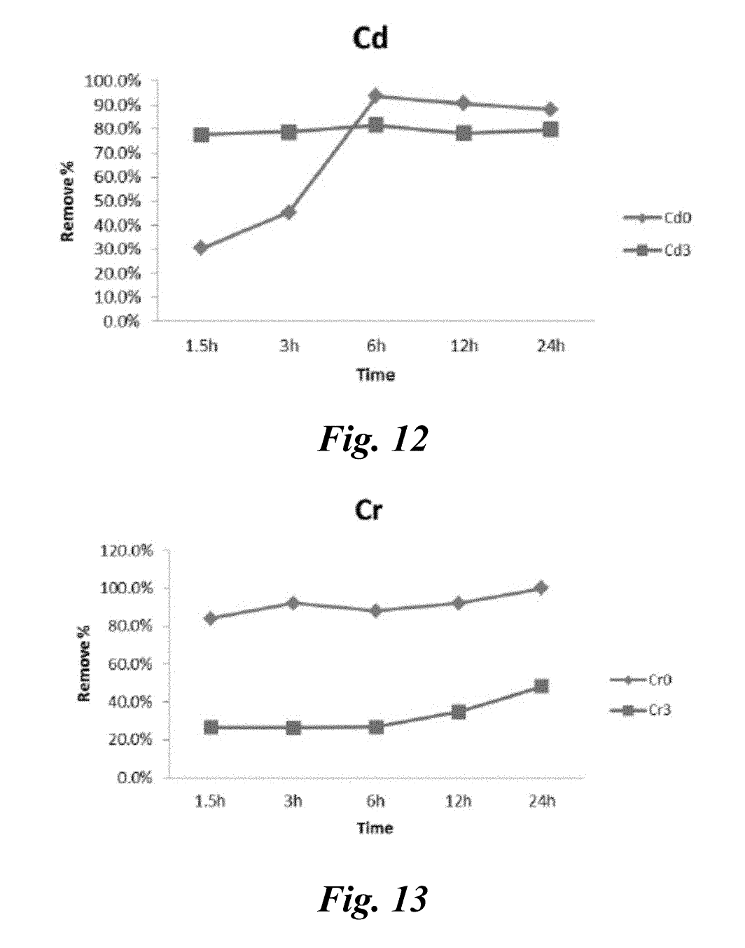

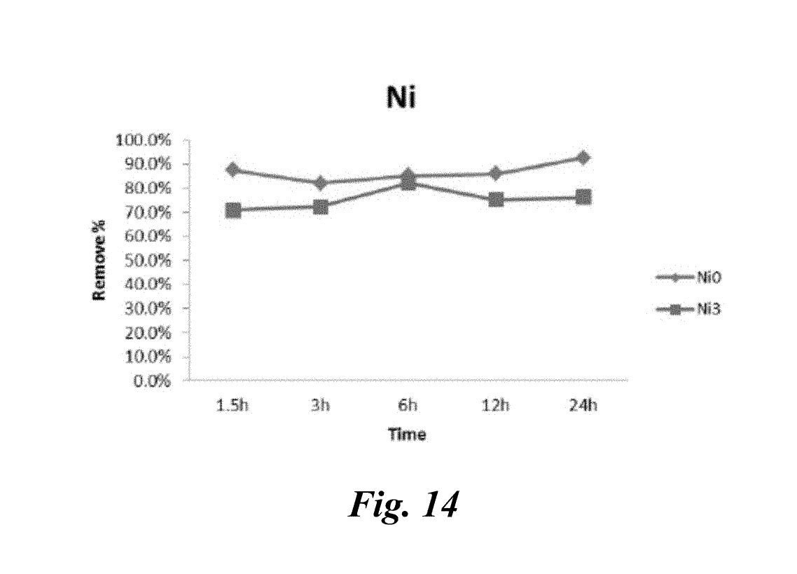

In order to quantify the effects of nanoparticle aggregation on removal efficiency, freshly synthesized and three weeks old PVP-Fe₃O₄NPs were used to remove metals (1 mg L⁻¹) from soft water. Results are shown in FIGS. 12-14. There was no significant difference of these two type NPs on Pb or Ni removal efficiency (need to insert data); however, there was a significant and substantial difference for Cr (FIG. 13), where the removal percentage is above 80% for fresh NPs but only 20-40% for three week old nanoparticles showing that these NPs must be used fresh and cannot be stored. For removal of Pb and Ni, storage is acceptable. For Ni (FIG. 14), the removal difference between fresh NPs (around 90%) and three-week old NPs (70-80%) was not as great as for Cr. For Cd (FIG. 12), the removal percentage by the aged NPs was slower, but similar to the fresh materials at contact times between 3 and 6 hours.

### Effect of Natural Organic Matter (Suwannee River Fulvic Acid, SRFA)

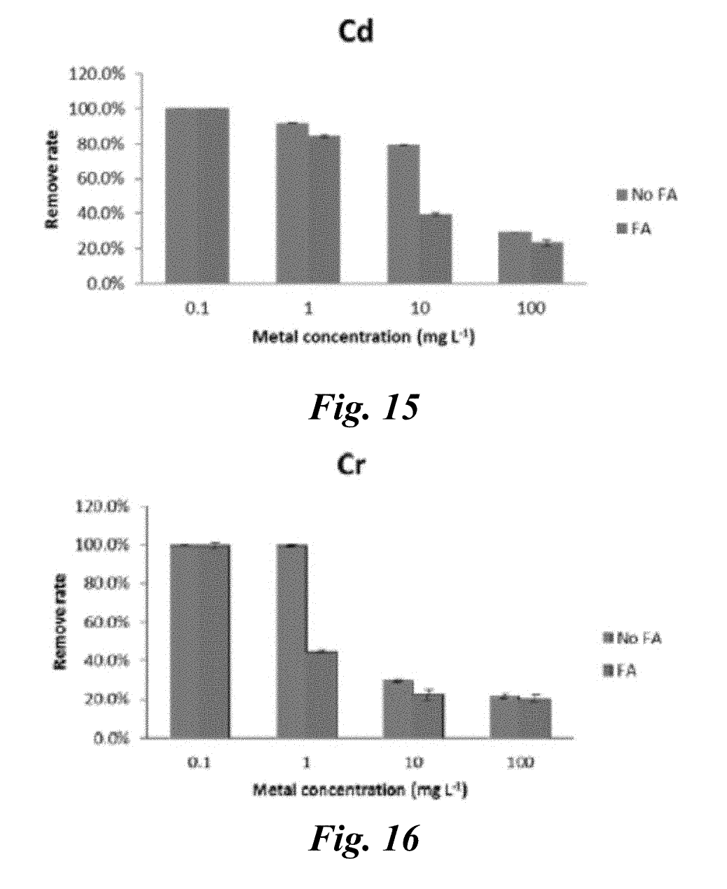

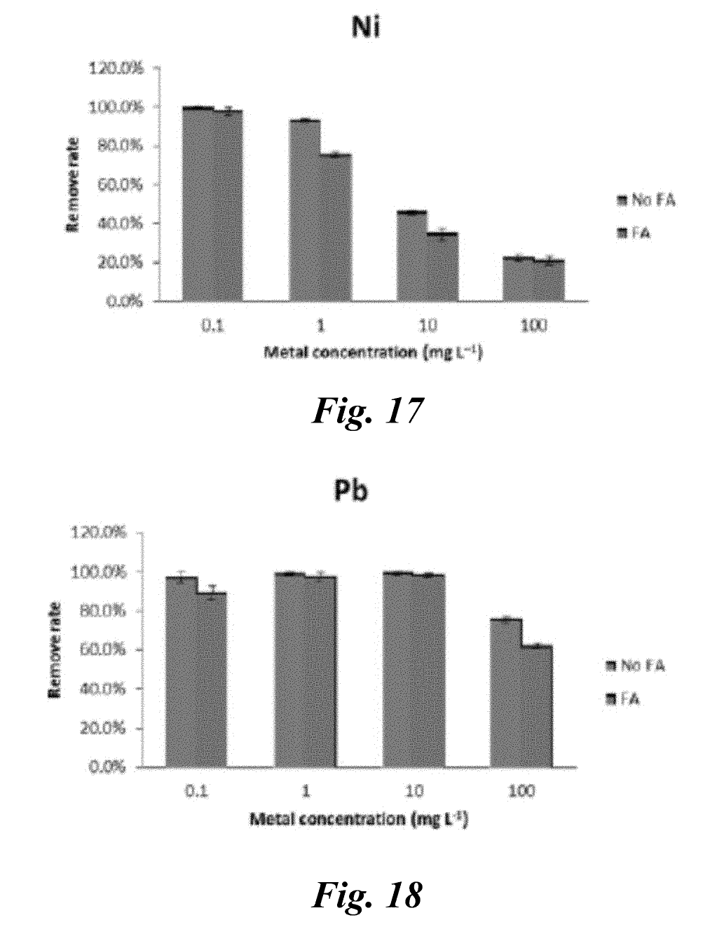

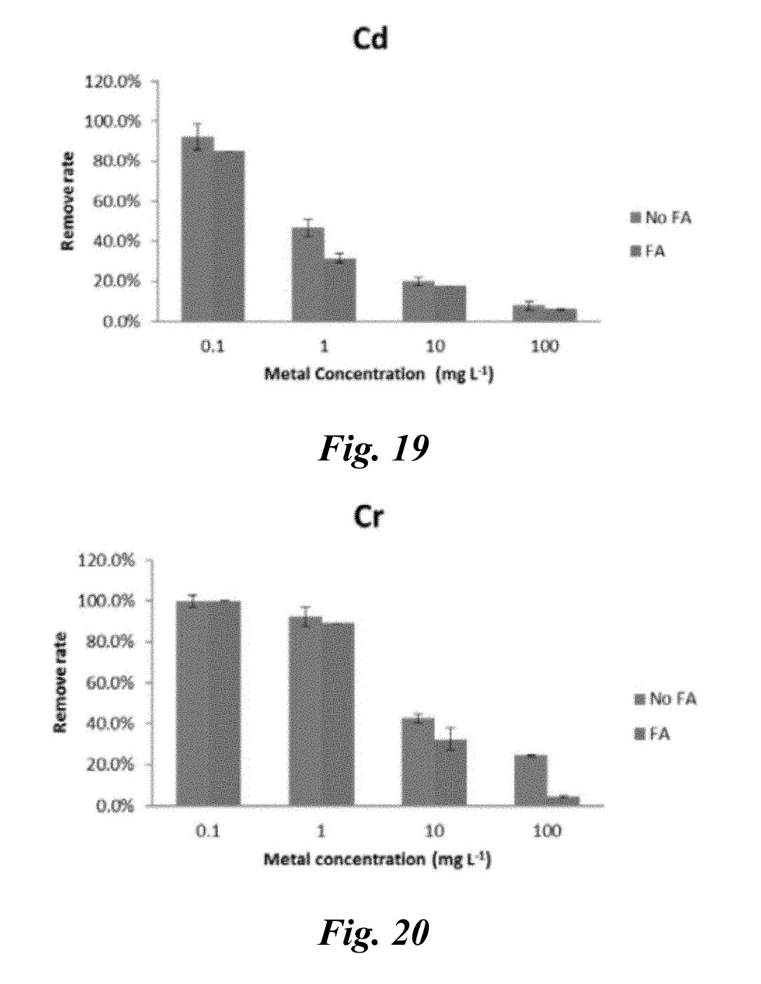

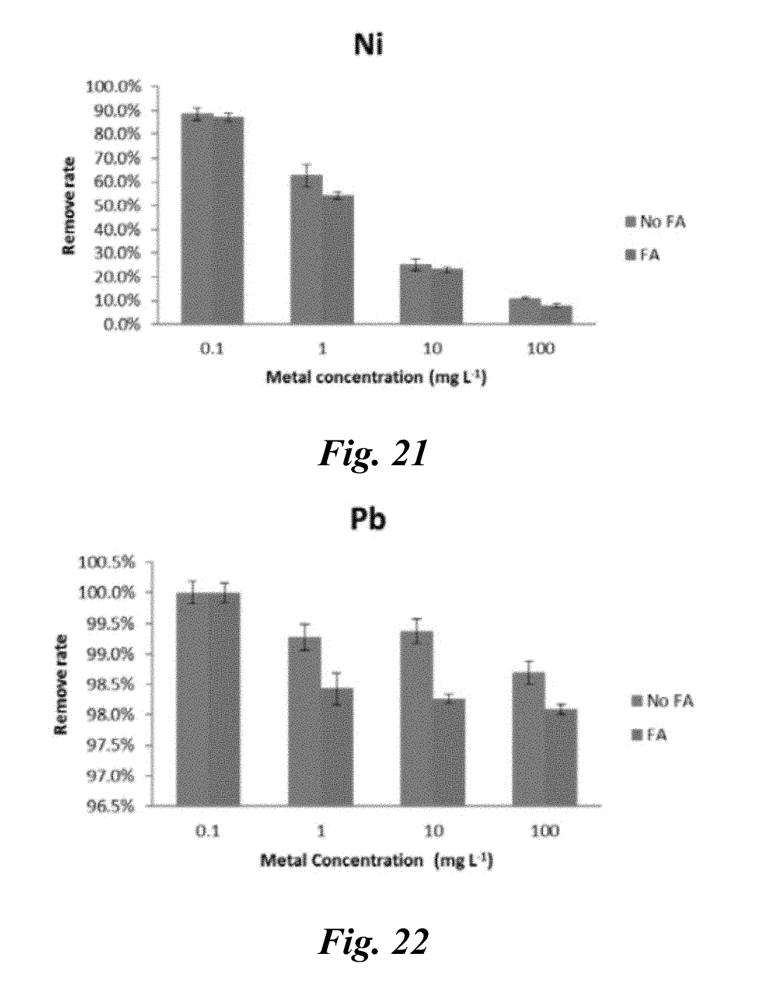

To mimic more exactly possible environmental conditions, metal removal tests in soft and sea waters in the presence of 0.5 mg/L Suwannee River Fulvic Acid (SRFA) were performed. The initial metal concentrations were 0.1 mg/L, 1 mg/L, 10 mg/L, and 100 mg/L, and the contact time was 24 hours. The effects of adding fulvic acid to the water media containing various concentrations of Cd, Cr, Ni, and Pb are shown in FIGS. 15-18 (soft water) and FIGS. 19-22 (sea water). The removal (as % of the total) for Pb is at least 60% and usually higher, even when Pb is present at an initial concentration of 100 mg/L. For the other three metals (Cd, Cr, and Ni), the SRFA does not reduce the removal percentage significantly for most conditions. However, there is a clear trend of reduced removal at high metal concentrations implying that i) the nanoparticles remove metals effectively at the likely conditions of polluted waters and ii) greater removal can be effected with increased additions of nanoparticles. The adsorption capacities in milligrams/gram of PVP-Fe₃O₄ for various conditions are shown in Table 2 for extremely challenging conditions (i.e., low nanoparticle concentrations and high metal concentrations). By altering the nanoparticle to metal ratios, 100% adsorption and removal has been achieved. For instance, at concentrations which are more representative of environmental concentrations (0.1 mg/L metal and 1 mg/L of metal), 90-100% removal has been effected for these metals.

TABLE 2
PVP-Fe₃O₄ Adsorption Capacity (mg/g) of 4 Metals in different Water
Media; n = 3. Very high concentrations of 10 mg/L were used.

| | soft water | | sea water | |
|---|---|---|---|---|
| | Without SRFA | With SRFA | Without SRFA | With SRFA |
| Cd | 43.92 | 23.66 | 12.08 | 11.62 |
| Cr | 17.98 | 13.87 | 25.52 | 22.89 |
| Ni | 29.86 | 21.23 | 15.01 | 13.47 |
| Pb | 61.67 | 55.33 | 59.62 | 20.19 |

Compared to other materials, PVP-Fe₃O₄ also exhibits higher Cr (VI) and Pb (II) removal capacity. Specifically, magnetite nanospheres have only been shown to adsorb 8.9 mg/g of Cr (VI), amino-modified Fe₃O₄ nanoparticles have only been shown to adsorb 11.24 mg/g of Cr (VI), and ceria hollow nanospheres have only been shown to adsorb 15.4 mg/g of Cr (VI). Further, magnetite nanospheres have only been shown to adsorb 18.47 mg/g of Pb (II), Fe₃O₄/SiO₂ nanocomposites have only been shown to adsorb 17.65 mg/g of Pb (II), MnO nanocomposites have only been shown to adsorb 21 mg/g of Pb (II), magnetic ion-imprinted polymer nanoparticles have only been shown to adsorb 48.1 mg/g of Pb (II), and magnetite nanoparticles have only been shown to adsorb 53.1 mg/g of Pb (II) in soft water without SRFA.

### CONCLUSION

In this study, PVP-Fe₃O₄ NPs were utilized for metal remediation in different environmentally relevant media. The NPs of the present invention can be synthesized through a facile, environmentally friendly, and cost-effective hydrothermal technique. Results show that these nanoparticles can remove metals ions efficiently in both soft water and sea water. The results for Pb removal are excellent, with maximum adsorption achieved in less than 1.5 hours, with a removal of up to 100% of the initial concentration of Pb. The removal of other metals was more variable but excellent removal could be achieved by varying the environmental conditions.

In summary, polyvinylpyrrolidone coated magnetic nanoparticles (PVP-Fe₃O₄ NPs) were used to remove metals (Cd, Cr, Ni, and Pb) from synthetic soft water and sea water in acidic or non-acidic conditions. The PVP-Fe₃O₄ NPs can remove up to about 100% of Cd, Cr, Ni, and Pb metals at a concentration of 0.1 mg/L and from about 80% to about 100% of Cd, Cr, Ni, and Pb metals at a concentration of 1 mg/L. The removal percentage decreased as the initial metal concentration increased, although essentially 100% of Pb was removed under all conditions and concentrations in 24 hours or less. The kinetic adsorption fitted well to the pseudo-second-order model. Water ionic strength, the presence of specific ions, and the presence of fulvic acid presence did not cause significant changes in removal effectiveness. In general, the majority of metal sorption occurred within the first 3 hours of treatment. These NPs are a reliable method to remove metals under a wide range of environmentally relevant conditions.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of extracting metal ions from a polluted liquid, the method comprising:
introducing the polluted liquid to a plurality of nanoparticles, wherein the nanoparticles each comprise a core and an organic shell; and
allowing metal ions in the polluted liquid to be adsorbed by the plurality of nanoparticles.

2. The method as in claim 1, further comprising:
removing the nanoparticles from the polluted liquid.

3. The method as in claim 2, wherein the core is magnetic, and wherein removing the nanoparticles from the multiphasic liquid is achieved utilizing a magnetic force.

4. The method as in claim 2, further comprising:
thereafter, recovering the metal ions adsorbed by the plurality of nanoparticles.

5. The method as in claim 1, wherein introducing the polluted liquid to a plurality of nanoparticles comprises: flowing the polluted liquid through a cartridge, wherein the cartridge comprises the plurality of nanoparticles.

6. The method as in claim 1, wherein the core comprises a metal oxide.

7. The method as in claim 6, wherein the metal oxide comprises iron oxide (Fe₃O₄), silica, alumina, indium tin oxide, titania, or a combination thereof.

8. The method as in claim 6, wherein the core comprises Fe₃O₄.

9. The method as in claim 1, wherein the organic shell comprises a polymer.

10. The method as in claim 9, wherein the polymer is a polyvinylpyrrolidone-based polymer having a molecular mass of about 10 kDa to about 360 kDa.

11. The method as in claim 1, wherein the organic shell comprises polyvinylpyrrolidone.

12. The method as in claim 1, wherein the core comprises Fe₃O₄ and the organic shell comprises polyvinylpyrrolidone.

13. The method as in claim 1, wherein the core has an average size that is about 100 nm or less.

14. The method as in claim 1, wherein the metal ions are present in the polluted liquid at a concentration ranging from about 0.001 milligrams per liter of polluted liquid to about 150 milligrams per liter of polluted liquid.

15. The method as in claim 1, wherein about 40% to about 100% of the metal ions are adsorbed by the plurality of nanoparticles within about 24 hours, wherein the metal ions are present at an initial concentration of up to about 1 milligram per liter of polluted liquid.

16. The method as in claim 1, wherein about 80% to about 100% of the metal ions are adsorbed by the plurality of nanoparticles within about 24 hours, wherein the metal ions are present at an initial concentration of up to about 1 milligram per liter of polluted liquid.

17. The method as in claim 1, wherein the plurality of nanoparticles have an adsorption capacity ranging from about 10 milligrams of metal ions per gram of nanoparticles to about 70 milligrams of metal ions per gram of nanoparticles.

18. The method as in claim 1, wherein the polluted liquid comprises metal ions of cadmium, chromium, nickel, zinc, lead, or a combination thereof.

19. The method as in claim 18, wherein the polluted liquid comprises lead.

20. The method as in claim 19, wherein about 90% to about 100% of the lead is adsorbed by the plurality of nanoparticles within about 3 hours, wherein the lead is present at an initial concentration of up to about 1 milligram per liter of polluted liquid.
